(19) United States
(12) Patent Application Publication
(10) Pub. No.: US 2024/0425057 A1
(43) Pub. Date: Dec. 26, 2024

(54) Electronic Driver Identification Assembly

(71) Applicants: Patrice Maxi, Queens Village, NY (US); Joshua Moliere, Queens Village, NY (US)

(72) Inventors: Patrice Maxi, Queens Village, NY (US); Joshua Moliere, Queens Village, NY (US)

(21) Appl. No.: 18/211,620

(22) Filed: Jun. 20, 2023

(51) Int. Cl. B60W 40/08; G06K 7/14; H04W 4/40

(52) U.S. Cl. CPC B60W 40/08; G06K 7/1417; H04W 4/40; B60W 2540/043

(57) ABSTRACT

An electronic driver identification assembly includes a vehicle that has a readable code printed on an outside of the vehicle. A remote data storage unit is included for storing data pertaining to the vehicle and a personal electronic device is carried by a driver of the vehicle. The personal electronic device stores driver data and the personal electronic device is in wireless communication with an extrinsic communication network to upload the driver data to the remote data storage unit. A code reader is carried by a law enforcement officer thereby facilitating the code reader to read the readable code printed on the vehicle when the law enforcement officer initiates a traffic stop. The code reader is in wireless communication with the extrinsic communication network thereby facilitating the code reader to download the driver data from the remote data storage unit.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to driver identification device and more particularly pertains to a new driver identification device for facilitating a law enforcement officer to remotely access driver data during a routine traffic stop. The device includes a readable code that is printed on an exterior of a vehicle and a remote data storage unit. The device includes a personal electronic device for uploading driver data of a driver of the vehicle. The device includes a code reader carried by a law enforcement officer which is in communication with the remote data storage unit. The code reader reads the readable code thereby facilitating the driver data to be downloaded into the code reader.

### (2) Description of Related Art Including Information Disclosed Under 37 CFR 1.97 and 1.98

The prior art relates to driver identification devices including a vehicle identification device that includes a license plate with alphanumeric characters and a holographic image that is readable by an electronic device. The prior art discloses a variety of vehicle identification devices that includes a probe device that is in wireless communication with a vehicle registration tag for remotely identifying the vehicle. The prior art discloses a vehicle identification device that includes a bar code reader which reads a barcode on a vehicle for downloading information about the vehicle.

### BRIEF SUMMARY OF THE INVENTION

An embodiment of the disclosure meets the needs presented above by generally comprising a vehicle that has a readable code printed on an outside of the vehicle. A remote data storage unit is included for storing data pertaining to the vehicle and a personal electronic device is carried by a driver of the vehicle. The personal electronic device stores driver data and the personal electronic device is in wireless communication with an extrinsic communication network to upload the driver data to the remote data storage unit. A code reader is carried by a law enforcement officer thereby facilitating the code reader to read the readable code printed on the vehicle when the law enforcement officer initiates a traffic stop. The code reader is in wireless communication with the extrinsic communication network thereby facilitating the code reader to download the driver data from the remote data storage unit.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective in-use view of an electronic driver identification assembly according to an embodiment of the disclosure.

FIG. 2 is a schematic view of an embodiment of the disclosure.

### DETAILED DESCRIPTION OF THE INVENTION

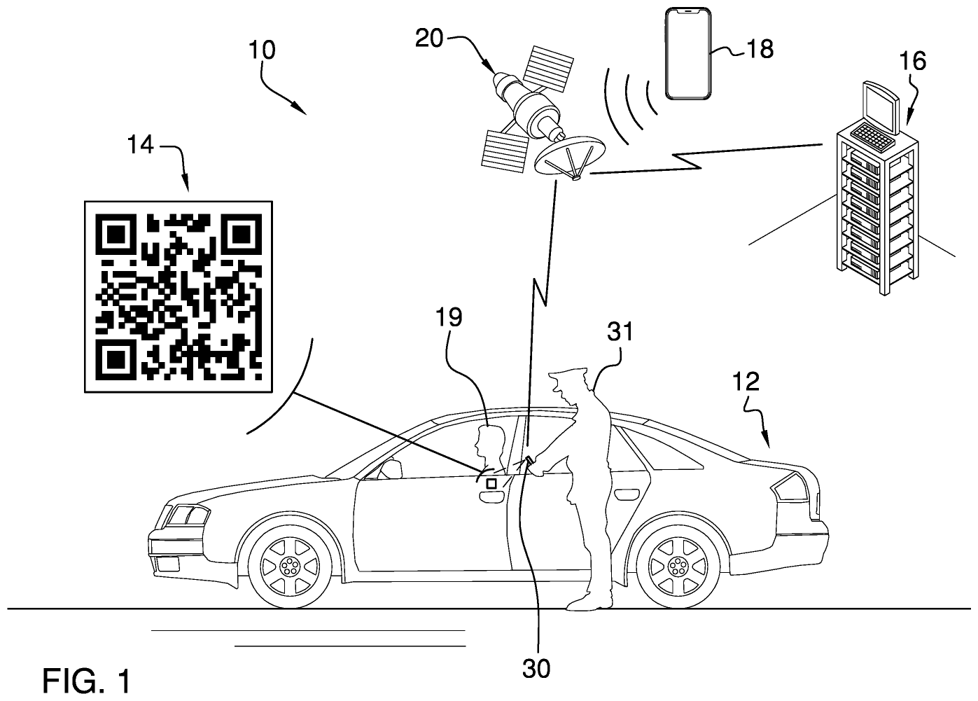

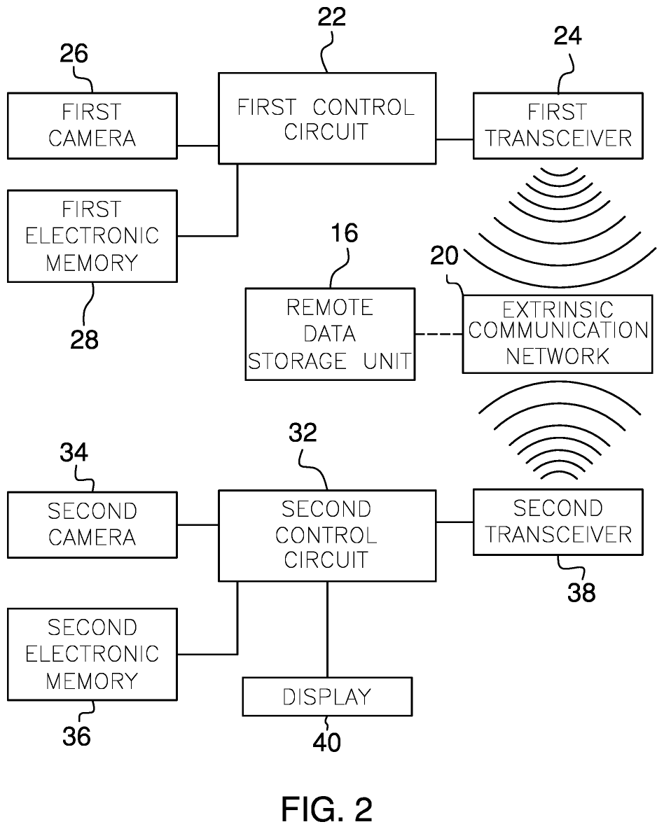

With reference now to the drawings, and in particular to FIGS. 1 through 2 thereof, a new driver identification device embodying the principles and concepts of an embodiment of the disclosure and generally designated by the reference numeral 10 will be described.

As best illustrated in FIGS. 1 through 2, the electronic driver identification assembly 10 generally comprises a vehicle 12 that has a readable code 14 printed on an outside of the vehicle 12. The vehicle 12 may be a passenger vehicle, a cargo vehicle or any other type of motorized vehicle that is licensed to be operated on public roadways. The readable code 14 may comprise a quick response code, a bar code or any other type of readable code that can be scanned with an optical device. A remote data storage unit 16 is included for storing data pertaining to the vehicle 12 and the remote data storage unit 16 may comprise a computer server or other similar device that is located in a data storage center.

A personal electronic device 18 is provided which is carried by a driver 19 of the vehicle 12. The personal electronic device 18 stores driver data pertaining to a driver's license, a vehicle registration and vehicle insurance pertaining to the driver 19 of the vehicle 12. Furthermore, the personal electronic device 18 is in wireless communication with an extrinsic communication network 20 thereby facilitating the personal electronic device 18 to be in remote communication with the remote data storage unit 16 to upload the driver data to the remote data storage unit 16.

The personal electronic device 18 includes a first control circuit 22 that is integrated into the personal electronic device 18 and a first transceiver 24 that is integrated into the personal electronic device 18. The first transceiver 24 is electrically coupled to the first control circuit 22 and the first transceiver 24 is in wireless communication with the extrinsic communication network 20. The first transceiver 24 may be a radio frequency transceiver or the like and the extrinsic communication network 20 may be a cellular phone network, the internet or any other type of wireless communication network. The personal electronic device 18 includes a first camera 26 thereby facilitating the first camera 26 to capture imagery of the driver's license and the vehicle registration and the vehicle insurance card, and the first camera 26 is electrically coupled to the first control circuit 22.

The personal electronic device 18 includes a first electronic memory 28 that is integrated into the personal electronic device 18 and the first electronic memory 28 is electrically coupled to the first control circuit 22. The first electronic memory 28 stores an operational program comprising an image processing program for processing the imagery captured by the first camera 26 thereby facilitating the first transceiver 24 to upload the imagery into the remote data storage unit 16. The personal electronic device 18 may comprise a smart phone, an electronic tablet or any other personal electronic device that has wireless communication capabilities and which is commonly employed for capturing photographs and transmitting digital data.

A code reader 30 is provided and the code reader 30 is carried by a law enforcement officer 31 thereby facilitating the code reader 30 to read the code is printed on the vehicle 12 when the law enforcement officer 31 initiates a traffic stop. The code reader 30 is in wireless communication with the extrinsic communication network 20 thereby facilitating the code reader 30 to download the driver data from the remote data storage unit 16. The code reader 30 comprises a second control circuit 32 that is integrated into the code reader 30 and the code reader 30 includes a second camera 34 that is integrated into the code reader 30 thereby facilitating the second camera 34 to capture imagery of the readable code 14 printed on the vehicle 12. The second camera 34 is electrically coupled to the second control circuit 32 and the second camera 34 may comprise a digital camera of any conventional design. The code reader 30 includes a second electronic memory 36 that is integrated into the code reader 30. The second electronic memory 36 is electrically coupled to the second control circuit 32 thereby facilitating the second electronic memory 36 to receive the imagery of the readable code 14 captured by the second camera 34.

A second transceiver 38 is integrated into the code reader 30 and the second transceiver 38 is in wireless communication with the extrinsic communication network 20 thereby facilitating the second transceiver 38 to download the imagery of the driver's license and the vehicle registration and the vehicle insurance card from the data storage unit which is associated with the readable code 14 printed on the vehicle 12. In this way the law enforcement officer 31 can view the driver's license and the vehicle registration and the vehicle insurance card without having to directly communicate with the driver 19. Thus, the code reader 30 enhances safety for the law enforcement officer 31 and the driver 19 during the traffic stop with respect to shootings that occur between law enforcement officers and drivers during traffic stops. Additionally, the second transceiver 38 is electrically coupled to the second control circuit 32.

The code reader 30 includes a display 40 that is integrated into the code reader 30 such that the display 40 is visible to the law enforcement officer 31. The display 40 is electrically coupled to the second control circuit 32 thereby facilitating the display 40 to display indicia comprising the driver's license and the vehicle registration and the vehicle identification card. Furthermore, the display 40 may comprise a liquid crystal display or other type of electronic display that can display imagery.

In use, the driver 19 uploads imagery of their driver's license and vehicle registration and vehicle insurance card prior to driving the vehicle 12. Furthermore, the imagery is stored in the remote data storage unit 16 and the imagery is associated with the readable code 14 that is printed on the vehicle 12. The law enforcement officer 31 scans the readable code 14 with the code reader 30 when the law enforcement officer 31 initiates a traffic stop. In this way the law enforcement officer 31 can verify the driver's license and vehicle registration and vehicle insurance card without having to directly communicate with the driver 19. Thus, the safety of the law enforcement officer 31 and the driver 19 is enhanced during routine traffic stops that might otherwise involve the accidental or intentional discharge of firearms during the traffic stop.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An electronic driver identification assembly for facilitating a law enforcement officer to electronically download information of a driver of a vehicle during a routine traffic stop, said assembly comprising:
a vehicle having a readable code printed on an outside of said vehicle;
a remote data storage unit for storing data pertaining to said vehicle;
a personal electronic device being carried by a driver of said vehicle, said personal electronic device storing driver data pertaining to a driver's license, a vehicle registration and vehicle insurance pertaining to the driver of said vehicle, said personal electronic device being in wireless communication with an extrinsic communication network thereby facilitating said personal electronic device to be in remote communication with said remote data storage unit to upload said driver data to said remote data storage unit; and
a code reader being carried by a law enforcement officer thereby facilitating said code reader to read said code being printed on said vehicle when the law enforcement officer initiates a traffic stop, said code reader being in wireless communication with said extrinsic communication network thereby facilitating said code reader to download the driver data from said remote data storage unit.

2. The assembly according to claim 1, wherein said personal electronic device includes:
a first control circuit being integrated into said personal electronic device; and
a first transceiver being integrated into said personal electronic device, said first transceiver being electrically coupled to said first control circuit, said first transceiver being in wireless communication with said extrinsic communication network.

3. The assembly according to claim 2, wherein said personal electronic device includes
a first camera being integrated into said personal electronic device thereby facilitating said first camera to capture imagery of the driver's license and the vehicle registration and the vehicle insurance card, said first camera being electrically coupled to said first control circuit; and
a first electronic memory being integrated into said personal electronic device, said first electronic memory being electrically coupled to said first control circuit, said first electronic memory storing an operational program comprising an image processing program for processing the imagery captured by said first camera thereby facilitating said first transceiver to upload the imagery into said remote data storage unit.

4. The assembly according to claim 1, wherein:
said personal electronic device includes a first control circuit and a first transceiver and a first camera and a first electronic memory; and
said code reader comprises:
a second control circuit being integrated into said code reader;
a second camera being integrated into said code reader thereby facilitating said second camera to capture imagery of said code printed on said vehicle, said second camera being electrically coupled to said second control circuit; and
a second electronic memory being integrated into said code reader, said second electronic memory being electrically coupled to said second control circuit thereby facilitating said second electronic memory to receive the imagery of said code captured by said second camera.

5. The assembly according to claim 4, wherein said code reader includes a second transceiver being integrated into said code reader, said second transceiver being in wireless communication with said extrinsic communication network thereby facilitating said second transceiver to download the imagery of the driver's license and the vehicle registration and the vehicle insurance card from said data storage unit which is associated with said code printed on said vehicle thereby facilitating the law enforcement officer to view the driver's license and the vehicle registration and the vehicle insurance card without having to directly communicate with the driver wherein said code reader is configured to enhance safety for the law enforcement officer and the driver during the traffic stop, said second transceiver being electrically coupled to said second control circuit.

6. An electronic driver identification assembly for facilitating a law enforcement officer to electronically download information of a driver of a vehicle during a routine traffic stop, said assembly comprising:
a vehicle having a readable code printed on an outside of said vehicle;
a remote data storage unit for storing data pertaining to said vehicle;
a personal electronic device being carried by a driver of said vehicle, said personal electronic device storing driver data pertaining to a driver's license, a vehicle registration and vehicle insurance pertaining to the driver of said vehicle, said personal electronic device being in wireless communication with an extrinsic communication network thereby facilitating said personal electronic device to be in remote communication with said remote data storage unit to upload said driver data to said remote data storage unit, said personal electronic device including:
a first control circuit being integrated into said personal electronic device;
a first transceiver being integrated into said personal electronic device, said first transceiver being electrically coupled to said first control circuit, said first transceiver being in wireless communication with said extrinsic communication network;
a first camera being integrated into said personal electronic device thereby facilitating said first camera to capture imagery of the driver's license and the vehicle registration and the vehicle insurance card, said first camera being electrically coupled to said first control circuit; and
a first electronic memory being integrated into said personal electronic device, said first electronic memory being electrically coupled to said first control circuit, said first electronic memory storing an operational program comprising an image processing program for processing the imagery captured by said first camera thereby facilitating said first transceiver to upload the imagery into said remote data storage unit;
a code reader being carried by a law enforcement officer thereby facilitating said code reader to read said code being printed on said vehicle when the law enforcement officer initiates a traffic stop, said code reader being in wireless communication with said extrinsic communication network thereby facilitating said code reader to download the driver data from said remote data storage unit, said code reader comprising:
a second control circuit being integrated into said code reader;
a second camera being integrated into said code reader thereby facilitating said second camera to capture imagery of said code printed on said vehicle, said second camera being electrically coupled to said second control circuit;
a second electronic memory being integrated into said code reader, said second electronic memory being electrically coupled to said second control circuit thereby facilitating said second electronic memory to receive the imagery of said code captured by said second camera;
a second transceiver being integrated into said code reader, said second transceiver being electrically coupled to said second control circuit, said second transceiver being in wireless communication with said extrinsic communication network thereby facilitating said second transceiver to download the imagery of the driver's license and the vehicle registration and the vehicle insurance card from said data storage unit which is associated with said code printed on said vehicle thereby facilitating the law enforcement officer to view the driver's license and the vehicle registration and the vehicle insurance card without having to directly communicate with the driver wherein said code reader is configured to enhance safety for the law enforcement officer and the driver during the traffic stop; and
a display being integrated into said code reader such that said display is visible to the law enforcement officer, said display being electrically coupled to said second control circuit thereby facilitating said display to display indicia comprising the driver's license and the vehicle registration and the vehicle identification card.

7. A method of facilitating a law enforcement officer to remotely access a driver's license and a vehicle registration and a vehicle insurance card during a routine traffic stop, the steps of the method comprising:
providing a wireless communication network;
providing a remote data storage unit;
providing a vehicle;
providing a readable code being printed on an outside of said vehicle;
providing a personal electronic device for capturing imagery of a driver's license and a vehicle registration and a vehicle insurance card pertaining to a driver of said vehicle;
providing a code reader being carried by a law enforcement officer;
uploading imagery of the driver's license and the vehicle registration and the vehicle insurance card into said remote data storage unit prior to driving said vehicle such that said imagery is associated with said readable code; and
scanning said readable code during a traffic stop such that a law enforcement officer can download the imagery of the driver's license and the vehicle registration and the vehicle insurance card during the traffic stop thereby facilitating the law enforcement officer to identify pertinent information about the driver without requiring direct communication between the law enforcement officer and the driver.
